(19) United States
(12) Patent Application Publication
(10) Pub. No.: US 2011/0293994 A1
(43) Pub. Date: Dec. 1, 2011

(54) BATTERY PACK ASSEMBLY USING CLAD ELECTRICAL CONNECTIONS

(75) Inventor: Daniel J. Casoli, Howell, MI (US)

(73) Assignee: GM GLOBAL TECHNOLOGY OPERATIONS LLC., Detroit, MI (US)

(21) Appl. No.: 13/090,685

(22) Filed: Apr. 20, 2011

Related U.S. Application Data
(60) Provisional application No. 61/348,942, filed on May 27, 2010.

(51) Int. Cl. H01M 2/26

(52) U.S. Cl. 429/158

(57) ABSTRACT

A battery pack assembly includes a first battery cell having a first electrical connection tab formed of a first material, a second battery cell having a first electrical connection tab formed of a second material, and a metal clad connection terminal having a first surface formed of the first material and a second surface formed of the second material, wherein the first electrical connection tab of the first battery cell is electrically connected to the first surface of the metal clad connection terminal, and the first electrical connection tab of the second battery cell is electrically connected to the second surface of the metal clad connection terminal.

### CROSS REFERENCE TO RELATED APPLICATIONS

This application is entitled to claim the benefit of, and claims priority to, U.S. provisional patent application Ser. No. 61/348,942 filed May 27, 2010, the entire disclosure of which is incorporated herein by reference.

### FIELD OF THE INVENTION

The present disclosure relates to a battery pack assembly, and more particularly to using a clad material to electrically interconnect a plurality of battery cell terminals within a battery pack assembly.

### BACKGROUND OF THE INVENTION

A battery cell has been proposed as a clean, efficient and environmentally responsible power source for an electric device such as an electric vehicle, for example. Typically, a plurality of individual battery cells is provided to supply an amount of electric power sufficient to operate the electric device. The plurality of individual battery cells must be physically supported and protected as well as be in electrical communication with each other and the electrical device. Further, it is often desired to provide cooling to the battery cells during a charging and a discharging thereof and venting of the battery cells.

A battery pack assembly is typically provided to support and protect the plurality of battery cells and facilitate placing individual battery cells in electrical communication with each other and with the associated electrical device. Battery cells, such as prismatic lithium-ion battery cells, are individually formed with first and second connection tabs corresponding to positive and negative connection tabs extending from a periphery thereof that are intended for series or parallel electrical interconnection with adjacent battery cells. The first and second connection tabs are also used as a mechanical connection within the battery pack assembly to stabilize the battery cell location prior to and during assembly thereof. It is desirable to mechanically and electrically connect adjacent individual battery cells with each other with a low electrical resistance connection, on the order of 30 micro-Ohms.

In some applications, the battery connection tabs are formed of dissimilar metals. For example, a first connection tab may be copper or a copper alloy, while a second connection tab may be aluminum or an aluminum alloy. When interconnected in a series configuration, the copper connection tab must be electrically and mechanically connected to the aluminum connection tab.

Battery cell manufacturers use an anodized coating on the aluminum connection tab of each battery cell to protect the aluminum connection tab from chemical attack inside the cell. The anodized coating is uniform and covers the entire connection tab, including the external portion of the cell tab extending from the periphery of the battery cell. The anodized coating is an electrical insulator that must be removed for effective electrical interconnection to a connection tab of an adjacent battery cell. According to the prior art, only aggressive joining processes, such as resistance welding, laser welding, chemical welding, ultrasonic welding, brazing and soldering, are able to remove the anodized coating, provide a low-resistance electrical connection, and provide a strong mechanical connection between the connection tabs of adjacent battery cells. Further, only aggressive joining processes are able to electrically and mechanically interconnect the connection tabs of battery cells that are made of dissimilar materials, such as aluminum and copper. Thus, the anodized coating limits the use of joining methods other than aggressive joining processes, preventing use of joining methods that simplify the manufacture of battery pack assemblies. Moreover, the aggressive joining processes do not provide joints that are reversible. It is desirable to develop simplified and potentially reversible joining techniques that are compatible with the anodized coating.

Aggressive joining techniques also require sufficient clearance and space within which to create the desired joint between dissimilar metals, and often must be performed as individual steps within a manufacturing process, which increase manufacturing time and complexity. Achieving reductions in battery cell size and in battery pack assembly size may interfere with or reduce available clearance and space, may reduce the efficiency of the aggressive joining techniques, and may prevent accomplishing multiple electrical joints within a single manufacturing process, thereby increasing manufacturing time. Thus, it is also desirable to provide battery cell electrical and mechanical interconnections that simplify and improve the battery pack assembly process.

### SUMMARY OF THE INVENTION

Concordant and consistent with the present invention, an assembly for joining together battery cell connection tabs formed of first and second materials to make smaller, more cost effective battery interconnections has surprisingly been discovered.

In one embodiment, a battery pack assembly comprises: a first battery cell having a first electrical connection tab formed of a first material; a second battery cell having a first electrical connection tab formed of a second material; and a metal clad connection terminal having a first surface formed of the first material and a second surface formed of the second material, wherein the first electrical connection tab of the first battery cell is electrically connected to the first surface of the metal clad connection terminal, and the first electrical connection tab of the second battery cell is electrically connected to the second surface of the metal clad connection terminal.

In another embodiment, a battery pack assembly comprises: a plurality of battery cells arranged in a stacked configuration, each of the battery cells including a first electrical connection tab formed from a first material and a second electrical connection tab formed from a second material; a first metal clad connection terminal having a first surface formed of the first material and a second surface formed of the second material, wherein the first electrical connection tab of a first one of the battery cells is electrically connected to the first surface of the first metal clad connection terminal, and the second electrical connection tab of a second one of the battery cells is electrically connected to the second surface of the first metal clad connection terminal; and a second metal clad connection terminal having a first surface formed of the first material and a second surface formed of the second material, wherein the first electrical connection tab of the second one of the battery cells is electrically connected to the first surface of the second metal clad connection terminal, and the second electrical connection tab of a third one of the battery cells is electrically connected to the second surface of the second metal clad connection terminal to electrically connect the battery cells in a series configuration.

In yet another embodiment, a battery pack assembly comprises: a first battery cell having a first electrical connection tab formed of a first material; a second battery cell having a first electrical connection tab formed of a second material; and a metal clad connection terminal having a first portion formed of the first material and a second portion formed of the second material, the second portion including a female recess to receive at least a part of the first portion therein, wherein the first electrical connection tab of the first battery cell is electrically connected to the first surface of the metal clad connection terminal, and the first electrical connection tab of the second battery cell is electrically connected to the second surface of the metal clad connection terminal.

### BRIEF DESCRIPTION OF THE DRAWINGS

FIG. 1 is a fragmentary schematic representation of a metal clad connection terminal disposed between a pair of connection tabs of a pair of battery cells according to an embodiment of the present invention;

FIG. 2 is a fragmentary schematic representation of a battery pack assembly including a plurality of the metal clad connection terminals of FIG. 1; and

FIG. 3 is a partially exploded schematic representation of a metal clad connection terminal disposed between a pair of connection tabs of a pair of battery cells according to another embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner.

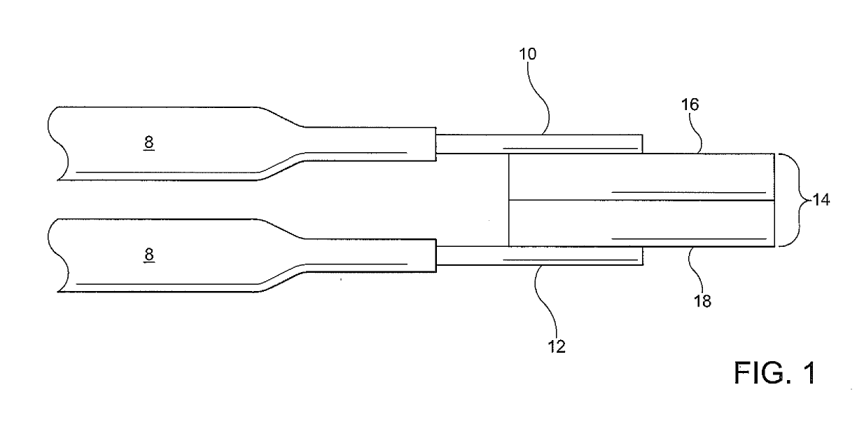

FIG. 1 illustrates a pair of battery cells 8 (e.g. prismatic lithium-ion battery cells) that are individually formed with a first connection tab 10 and a second connection tab 12 extending outwardly from a periphery thereof. Each of the connection tabs 10, 12 provides a means to electrically interconnected (e.g. series, parallel, or any other electrical configuration) any number of the battery cells 8.

In certain embodiments, the first connection tab 10 is formed from a first material such as aluminum or an aluminum alloy, for example. The second connection tab 12 is typically formed from a second material that is dissimilar to the first material such as copper or a copper alloy, for example. It is understood that the first connection tab 10 and the second connection tab 12 may be formed from any conductive material, and may further be formed of a same or similar conductive materials, as desired. When a plurality of the battery cells 8 is arranged in a series connected configuration, the first connection tab 10 of a first one of the battery cells 8 is electrically interconnected with a second connection tab 12 of a second one of the battery cells 8. In the embodiment shown in FIG. 1, an aluminum connection tab (e.g. the first connection tab 10) of the first one of the battery cells 8 is electrically interconnected with a copper connection tab (e.g. the second connection tab 12) of the second one of the battery cells 8.
1. According to the present disclosure, a metal clad connection terminal 14 is used to interconnect the first connection tab 10 of the first one of the battery cells 8 to the second connection tab 12 of the second one of the battery cells 8. In the embodiment shown, a first portion 16 of the metal clad connection terminal 14 is formed from the same material as the first battery connection tab 10, which is aluminum. A second portion 18 of the metal clad connection terminal 14 is formed from the same material as the second battery connection tab 12, which is copper. Because the first connection tab 10 can include an anodized surface, the first connection tab 10 of the first one of the battery cells 8 is joined to the first portion 16 of the metal clad connection terminal 14 by an aggressive joining process (e.g. laser welding, ultrasonic welding, and the like) to provide an acceptable mechanical and electrical connection therebetween. The second connection tab 12 of the second one of the battery cells 8 does not typically include an anodized surface. As a result, the second connection tab 12 is electrically joined to the second portion 18 of the metal clad connection terminal 14 by compression joining (e.g. by compression devices, clips, bolts, rivets, and the like) the second battery connection tab 12 formed from copper against the second portion 18 formed from copper of the metal clad connection terminal 14 to provide a low electrical resistance connection, on the order of 30 micro-Ohms or less, for example. A conductive path exists between the first portion 16 and the second portion 18 of the metal clad connection terminal 14 because the aluminum material and the copper material are clad directly to each other. As a non-limiting example, the first portion 16 of the metal clad connection terminal 14 can be removably electrically and mechanically interconnected to the second portion 18 of the metal clad connection terminal 14 by one of a compression joint, a clip joint, and a male-female joint. However, other joining processes can be used.

A compression joint between the second connection tab 12 of the second one of the battery cells 8 and the second portion 18 of the metal clad connection terminal 14 is reversible, because the second battery connection tab 12 formed from copper is not mechanically attached to the second portion 18 formed from copper of the metal clad connection terminal 14.

In certain embodiments, the metal clad connection terminal 14 may be eliminated altogether by forming a portion of each of the connection tabs 10, 12 of each of the battery cells 8 from a clad material, In this arrangement, each of the connection tabs 10, 12 includes a first surface (not shown) formed from a first material and a second surface (not shown) formed from a second material. The first material of a first one of the connection tabs 10, 12 is arranged in facing contact with the first material of a second one of the connection tabs 10, 12 for electrical interconnection therewith. Similarly, the second material of at least one of the connection tabs 10, 12 is arranged in facing contact with the second material of one of the connection tabs 10, 12 of an adjacent one of the battery cells 8 for electrical interconnection therewith. It is understood that the connection tabs 10, 12 may be interconnected by an aggressive joining process or by a compression joint, depending upon the first and second materials.

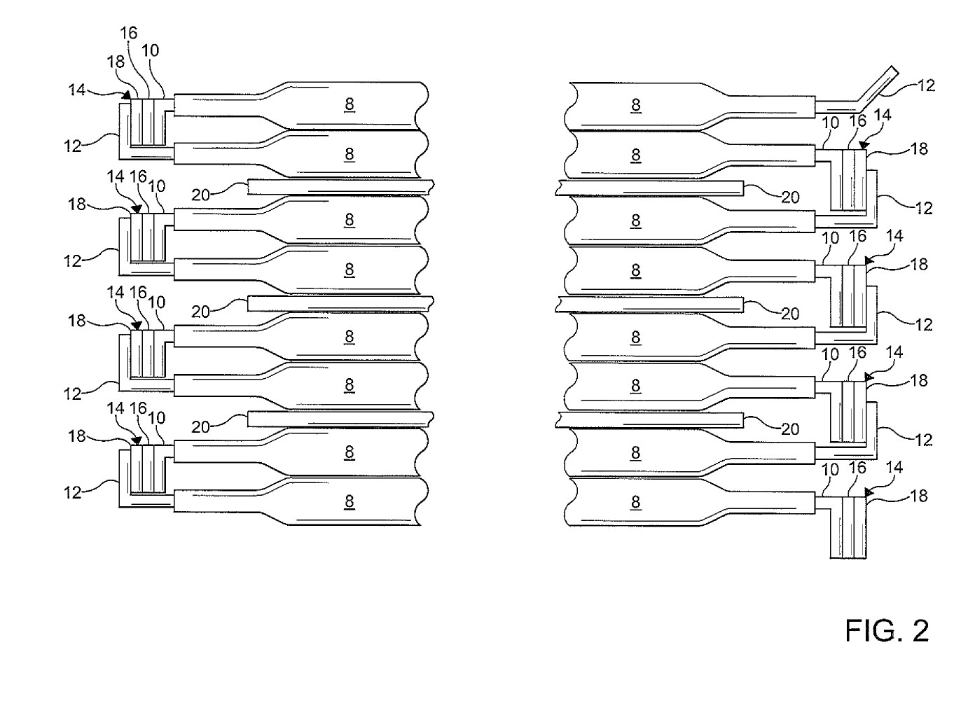

As shown in FIG. 2, a plurality of the metal clad connection terminals 14 may be used with a stack of the battery cells 8 having cooling devices 20 (e.g. cooling plates) disposed therebetween, thereby forming a battery pack assembly or a battery pack. The first portion 16 of the metal clad connection terminal 14 may be mechanically and electrically joined to the first connection tab 10 formed from aluminum of one of the battery cells 8 by an aggressive joining process, such as one of resistance welding, laser welding, chemical welding, ultrasonic welding, brazing and soldering. The aggressive joining process removes or breaks through the anodized coating on the first connection tab 10, providing a low resistance electrically conductive path through the first connection tab 10 to the metal clad connection terminal 14. The first connection tab 10, including the metal clad connection terminal 14, may be bent or otherwise arranged to allow the second connection tab 12 of an adjacent one of the battery cells 8 to be joined to the second portion 18 of the metal clad connection terminal 14. The second connection tab 12 may be joined to the second portion 18 of the metal clad connection terminal 14 by the same aggressive joining process.

In the embodiment shown, a plurality of the battery cells 8 may be prepared wherein each of the first connection tabs 10 of the plurality of battery cells 8 is joined to the first portion 16 of a respective one of the metal clad connection terminals 14. Each of the first connection tabs 10 may be bent in a first direction to expose the second portion 18 of the respective metal clad connection terminals 14, and each of the second connection tabs 12 of the battery cells 8 may be bent in a second direction to place the second connection tabs 12 adjacent and in facing relationship with the second portion 18 of the respective metal clad connection terminals 14, The battery cells 8 may be stacked in a series-connected arrangement so a top surface of each of the second connection tabs 12 is placed adjacent and in facing relationship with the second portion 18 of the metal clad connection terminal 14 attached to the first connection tab 10 of an adjacent one of the battery cells 8. The second connection tab 12 may be joined to the second portion 18 of the metal clad connection terminal 14 with an aggressive joining process. It is understood that each pair of the battery cells 8 may be stacked separately to allow for the second connection tabs 12 to be consecutively joined to respective second portions 18 of the metal clad connection terminals 14. However, favorable results have been obtained wherein a predetermined plurality of the battery cells 8 is stacked and arranged in a first step to allow for all of the second connection tabs 12 of the battery cells 8 to be attached to the respective second portions 18 of the metal clad connection terminals 14 attached to the adjacent ones of the battery cells 8 in a single process step, thereby minimizing the manufacturing time and complexity of the battery pack assembly. Folding over the connection tabs 10, 12 also minimizes a size of the battery pack assembly.

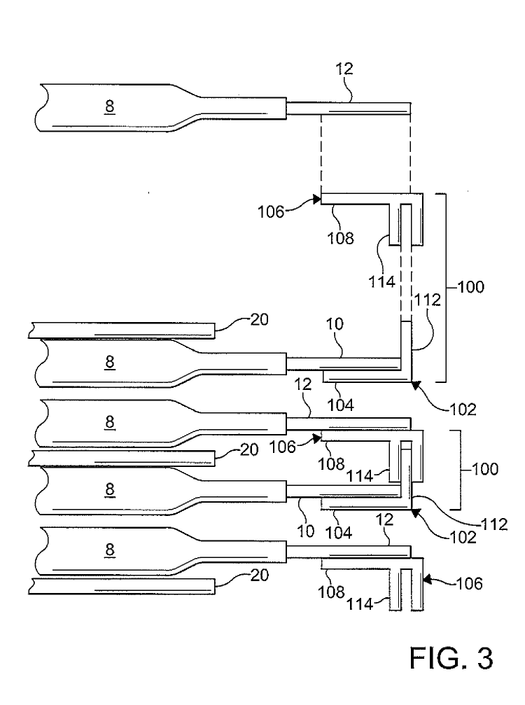

Use of the metal clad connection terminal 14 also enables multiple flexible and reversible electrical interconnection options. By way of example, FIG. 3 illustrates a metal clad connection terminal 100 similar to the metal clad connection terminal 14, except as described hereinbelow. As shown, the metal clad connection terminal 100 includes a first portion 102 that includes a first surface 104, and a second portion 106 that includes a second surface 108. For illustration, the first connection tab 10 of each of the battery cells 8 and the first portion 102 (e.g. at least the first surface 104) of the metal clad connection terminal 100 will be described as being formed of aluminum and the second connection tab 12 of each of the battery cells 8 and the second portion 106 (e.g. at least the second surface 108) of the metal clad connection terminal 100 will be described as being formed of copper. However, it is understood that the first connection tab 10 and the second connection tab 12 of each of the battery cells 8 and the first portion 102 and the second portions 106 of each of the metal clad connection terminals 100 may be formed from any electrically conductive material as desired. Favorable results have been obtained where the first connection tabs 10 and the first portion 102 of each of the metal clad connection terminals 100 are formed of similar materials, and the second connection tabs 12 and the second portions 106 of each of the metal clad connection terminals 100 are likewise formed of similar materials.

The first connection tab 10 of each of the battery cells 8 shown in FIG. 3 is electrically and mechanically connected to the first surface 104 of the first portion 102 of the metal clad connection terminal 100 by an aggressive joining process, such as one of resistance welding, laser welding, chemical welding, ultrasonic welding, brazing and soldering. The second connection tab 12 of each of the battery cells 8 is electrically and mechanically connected to the second surface 108 of the second portion 106 of the metal clad connection terminal 100 by the aggressive joining process. In FIG. 3, the first portion 102 of the metal clad connection terminal 100 includes a male projection 112, and the second portion 106 of the metal clad connection terminal 100 includes a female recess 114 for removably receiving the male projection 112 of the first portion 102 of the metal clad connection terminal 100.

Once each of the first surfaces 104 of the respective first portions 102 of the metal clad connection terminals 100 is attached to respective first connection tabs 10 of the battery cells 8 and each of the second surfaces 108 of the respective second portions 106 of the metal clad connection terminals 100 is attached to respective second connection tabs 12 of the battery cells 8, the battery cells 8 may be arranged into a series-connected stacked configuration by removably interconnecting the male projections 112 and the female recesses 114 of adjacent ones of the connection tabs 10, 12. It is understood that the first portions 102 and the second portions 106 of the metal clad connection terminals 100 may be formed from any material to optimize the removable electrical connection therebetween. It is understood that the removable electrical connection between the first portion 102 and the second portion 106 of the metal clad connection terminals 100 may be formed as any type of joint, including as a compression joint, a clip joint, and a male-female joint.

The present invention minimizes the inherent difficulties of an anodized coating, allowing the use of other joining methods that will simplify the assembly process and offer reversible joints. For example, current battery tabs are aluminum with anodized plating, wherein it is very difficult to achieve good electrical conductivity when joining to dissimilar metals. In certain embodiments, b joining an aluminum and copper clad material on the aluminum tab, this enables various joining methods such as compression joining. Currently, compression joining is not feasible due to the anodized coating, but once a clad material of aluminum and copper is used (i.e. the metal clad connection terminal 14, 100), compression becomes possible and allows for a reversible joint.

Further, as batteries continue to get smaller, known assembly processes become inefficient or non-attainable due to small clearances required. The metal clad connection terminal 14, 100 of the present invention allows for laser joining, compression, clips, and other methods for joining similar metals. Folding over battery tabs (e.g. the connections tabs 10, 12) minimizes a battery package size. Arrangements that include enclosed battery pack assemblies require small joining spaces, which yield lighter and cheaper batteries that can be laser welded using similar metals. Also, metal clad materials can result in few parts by taking advantage of conductive properties and eliminating welding of low voltage sensor parts.

Finally, the present invention eliminates the need for aggressively joining dissimilar metals. Using clad metals, aggressive joining of similar metals becomes feasible and cost effective, and further allows for smaller battery designs by folding battery tabs over. Also, using the correct clad metal configuration, it is possible to eliminate the welding of an interconnect board to the connection tabs to minimize cost and the number of parts. Clad materials also provide a multitude of possible metal combinations to enable flexible use of various joining methods, minimize cost and size, and make the creation of reversible joints possible.

While certain representative embodiments and details have been shown for purposes of illustrating the invention, it will be apparent to those skilled in the art that various changes may be made without departing from the scope of the disclosure, which is further described in the following appended claims.

What is claimed is:

1. A battery pack assembly comprising:
a first battery cell having a first electrical connection tab formed from a first material;
a second battery cell having a first electrical connection tab formed from a second material; and
a metal clad connection terminal having a first portion formed from the first material and a second portion formed from the second material, wherein the first electrical connection tab of the first battery cell is electrically connected to the first portion of the metal clad connection terminal, and the first electrical connection tab of the second battery cell is electrically connected to the second portion of the metal clad connection terminal.

2. The battery pack assembly of claim 1, wherein the first portion of the metal clad connection terminal is removably electrically and mechanically interconnected to the second portion of the metal clad connection terminal by one of a compression joint, a clip joint, and a male-female joint.

3. The battery pack assembly according to claim 1, wherein the first material is aluminum.

4. The battery pack assembly according to claim 1, wherein the second material is copper.

5. The battery pack assembly according to claim 1, wherein the first portion of the metal clad connection terminal is coupled to the first electrical connection tab using an aggressive joining process.

6. The battery pack assembly according to claim 1, wherein the second portion of the metal clad connection terminal is releasably coupled to the second electrical connection tab using compression joining.

7. The battery pack assembly according to claim 1, wherein each of the electrical connection tabs extends outwardly from a surface of the respective one of the battery cells.

8. The battery pack assembly according to claim 1, wherein at least one of the first electrical connection tab and the second electrical connection tab includes a bent or angled portion.

9. A battery pack assembly comprising:
a plurality of battery cells arranged in a stacked configuration, each of the battery cells including a first electrical connection tab formed from a first material and a second electrical connection tab formed from a second material;
a first metal clad connection terminal having a first portion formed from the first material and a second portion formed from the second material, wherein the first electrical connection tab of a first one of the battery cells is electrically connected to the first portion of the first metal clad connection terminal, and the second electrical connection tab of a second one of the battery cells is electrically connected to the second portion of the first metal clad connection terminal; and
a second metal clad connection terminal having a first portion formed from the first material and a second portion formed from the second material, wherein the first electrical connection tab of the second one of the battery cells is electrically connected to the first portion of the second metal clad connection terminal, and the second electrical connection tab of a third one of the battery cells is electrically connected to the second portion of the second metal clad connection terminal to electrically connect the battery cells in a series configuration.

10. The battery pack assembly of claim 9, wherein the battery cells are arranged in an alternating configuration to substantially align the first electrical connection tab of one of the battery cells with the second electrical connection tab of an adjacent one of the battery cells.

11. The battery pack assembly of claim 9, wherein the first portion of the metal clad connection terminal is removably electrically and mechanically interconnected to the second portion of the metal clad connection terminal by one of a compression joint, a clip joint, and a male-female joint.

12. The battery pack assembly according to claim 9, wherein the first portion of the metal clad connection terminal is coupled to the first electrical connection tab using an aggressive joining process.

13. The battery pack assembly according to claim 9, wherein the second portion of the metal clad connection terminal is releasably coupled to the second electrical connection tab using compression joining.

14. The battery pack assembly according to claim 8, wherein at least one of the first electrical connection tab and the second electrical connection tab includes a bent or angled portion.

15. A battery pack assembly, comprising:
a first battery cell having a first electrical connection tab formed of a first material;
a second battery cell having a first electrical connection tab formed of a second material; and
a metal clad connection terminal having a first portion formed of the first material and a second portion formed of the second material, the second portion including a female recess to receive at least a part of the first portion therein, wherein the first electrical connection tab of the first battery cell is electrically connected to the first portion of the metal clad connection terminal, and the first electrical connection tab of the second battery cell is electrically connected to the second portion of the metal clad connection terminal.

16. The battery pack assembly of claim 15, wherein the first electrical connection tab extends outwardly from a surface of the first battery cell and the second electrical connection tab extends outwardly from a surface of the second battery cell.

17. The battery pack assembly of claim 15, wherein the battery cells are arranged in an alternating configuration to substantially align the first electrical connection tab of the first battery cell with the second electrical connection tab of the second battery cell.

18. The battery pack assembly according to claim 15, wherein the first portion of the metal clad connection terminal is coupled to the first electrical connection tab using an aggressive joining process.

19. The battery pack assembly according to claim 15, wherein the second portion of the metal clad connection terminal is releasably coupled to the second electrical connection tab using compression joining.

20. The battery pack assembly according to claim 15, wherein at least one of the first electrical connection tab and the second electrical connection tab includes a bent or angled portion.
